(19) United States
(12) Patent Application Publication
(10) Pub. No.: US 2020/0183075 A1
(43) Pub. Date: Jun. 11, 2020

(54) DISPLAY DEVICE AND GAME MACHINE

(71) Applicant: OMRON CORPORATION, Kyoto-shi, Kyoto (JP)

(72) Inventors: Masanori MORI, Kyoto (JP); Yoshihiko TAKAGI, Kyoto (JP); Jun KISHIMOTO, Kyoto (JP); Shohei HISAKI, Kyoto (JP); Junya FUJITA, Kyoto (JP); Shogo IKEDA, Kyoto (JP)

(73) Assignee: Omron Corporation, Kyoto (JP)

(21) Appl. No.: 16/614,518

(22) PCT Filed: Jul. 23, 2018
(86) PCT No.: PCT/JP2018/027541

§ 371 Date: Nov. 18, 2019

(30) Foreign Application Priority Data
Aug. 10, 2017 (JP) 2017-155764

(51) Int. Cl. F21V 8/00; F21V 23/00; A63F 7/02

(52) U.S. Cl. CPC G02B 6/0036; A63F 7/027; F21V 23/003; G02B 6/0068

(57) ABSTRACT

A display device includes: a light guide plate (2) configured to display at least one pattern, the light guide plate including at least one incident surface; a plurality of light sources (3-1 to 3-3) configured to emit light beams having different colors, the plurality of light sources being disposed to be opposed to any one of the at least one incident surface; and a controller (6) configured to control turn-on and turn-off of each light source according to turn-on control information designating one light source to be turned on. A plurality of prisms (11) that are arrayed along a pattern (21) on one surface of the light guide plate (2) and reflect the light beam emitted from each light source and incident on the light guide plate from the incident surface such that the light beams exit from the other surface of the light guide plate are formed, and arrangement density of the prisms that reflect the light beam from the light source among the plurality of prisms (11) is set for each of the plurality of light sources (3-1 to 3-3) according to color of the pattern (21) when each light source is turned on.

### TECHNICAL FIELD

The present invention relates to a display device capable of displaying a pattern in color and a game machine including the display device.

### BACKGROUND ART

Conventionally, there has been proposed a technique of allowing a displayed pattern to be dynamically switched according to a light source to be turned on among a plurality of light sources (for example, see Patent Document 1).

For example, the display device disclosed in Patent Document 1 includes a light guide plate capable of displaying a plurality of patterns, a plurality of light sources arranged along one side of the light guide plate, and a controller that controls turn-on and turn-off of the plurality of light sources according to turn-on order information. The light guide plate includes a plurality of prisms arrayed on one of surfaces of the light guide plate along the pattern for each pattern, the plurality of prisms reflecting visible light toward the other surface of the light guide plate, the visible light being emitted from the light source corresponding to the pattern among the plurality of light sources and being incident on the light guide plate from an incident surface of the light guide plate.

### PRIOR ART DOCUMENTS

### Patent Document

Patent Document 1: Japanese Unexamined Patent Publication No. 2017-107048

### SUMMARY OF THE INVENTION

### Problems to be Solved by the Invention

The display device disclosed in Patent Document 1 can change the color every pattern by varying emission colors of a plurality of light sources. However, in the display device, because the pattern color becomes the emission color of the corresponding light source, the representable pattern color is restricted to the emission color of the light source used. In the display device in which the light guide plate is used, there is a demand for increasing a number of types of colors representing the pattern provided on the light guide plate.

An object of the present invention is to provide a display device capable of increasing the types of colors representing the pattern provided on the light guide plate.

### Means for Solving the Problem

According to one aspect of the present invention, a display device is provided. The display device includes: a light guide plate configured to display at least one pattern, the light guide plate being made of a transparent material and including at least one incident surface; a plurality of light sources configured to emit light beams having different colors, the plurality of light sources being disposed to be opposed to any one of the at least one incident surface; and a controller configured to control turn-on and turn-off of the plurality of light sources according to turn-on control information designating at least one light source to be turned on among the plurality of light sources. The light guide plate includes a plurality of prisms that are arrayed along the pattern on one surface of the light guide plate and reflect the light beams emitted from the plurality of light sources and incident on the light guide plate from the incident surface such that the light beams exit from the other surface of the light guide plate, and arrangement density of the prisms that reflect the light beam from the light source among the plurality of prisms is set for each of the plurality of light sources according to color of the pattern when each of the plurality of light sources is turned on.

In the display device, preferably the turn-on control information further includes a parameter designating emission luminance of each of the at least one light source to be turned on.

In the display device, preferably the turn-on control information further designates order in which each of the plurality of light sources becomes the at least one light source to be turned on.

In the display device, preferably the plurality of patterns include a first sub-pattern having a first color when each of the plurality of light sources is turned on and a second sub-pattern having a second color when each of the plurality of light sources is turned on, according to the first color, the arrangement density of the prisms arrayed along the first sub-pattern and reflecting the light beam from each light source among the plurality of prisms is set for each of the plurality of light sources, and according to the second color, the arrangement density of the prisms arrayed along the second sub-pattern and reflecting the light beam from each light source among the plurality of prisms is set for each of the plurality of light sources.

According to another aspect of the present invention, a game machine is provided. The game machine includes: a game machine body; and a display device provided on a surface of the game machine body on a side opposed to a player, in which the display device includes: a light guide plate configured to display at least one pattern, the light guide plate being made of a transparent material and including at least one incident surface; a plurality of light sources configured to emit light beams having different colors, the plurality of light sources being disposed to be opposed to any one of the at least one incident surface; and a controller configured to control turn-on and turn-off of the plurality of light sources according to turn-on control information designating at least one light source to be turned on among the plurality of light sources. The light guide plate includes a plurality of prisms that are arrayed along the pattern on one surface of the light guide plate and reflect the light beams emitted from the plurality of light sources and incident on the light guide plate from the incident surface such that the light beams exit from the other surface of the light guide plate, and arrangement density of the prisms that reflect the light beam from the light source among the plurality of prisms is set for each of the plurality of light sources according to color of the pattern when each of the plurality of light sources is turned on.

### Effect of the Invention

The display device of the present invention has the effect that the types of colors representing the pattern provided on the light guide plate can be increased.

### BRIEF DESCRIPTION OF THE DRAWINGS

FIG. 1 is a schematic configuration diagram illustrating a display device according to a first embodiment of the present invention.

FIG. 2 is a schematic front view illustrating a light guide plate included in the display device.

FIG. 3 is a schematic sectional side view illustrating the light guide plate taken along line A-A′ in FIG. 2.

FIG. 4A is a schematic front view of a prism.

FIG. 4B is a schematic perspective view of the prism.

FIG. 4C is a schematic side view of the prism.

FIG. 4D is a schematic sectional view illustrating the prism taken along line B-B′ in FIG. 4A.

FIG. 5 is a view illustrating an example of a relationship between a combination of light sources to be turned on and a color of each sub pattern.

FIG. 6A is a view illustrating an example of a shape of a prism according to a fourth modification.

FIG. 6B is a view illustrating an example of the shape of the prism of the fourth modification.

FIG. 7 is a schematic front view illustrating a prism according to a fifth modification.

FIG. 8A is a schematic front view illustrating a prism according to a sixth modification.

FIG. 8B is a schematic side view illustrating the prism of the sixth modification.

FIG. 9 is a schematic front view illustrating a display device according to a seventh modification.

FIG. 10 is a schematic perspective view illustrating a pinball game machine including the display device of the embodiment or the modifications when the pinball game machine is viewed from a player side.

### MODE FOR CARRYING OUT THE INVENTION

Hereinafter, a display device according to an embodiment of the present invention will be described with reference to the drawings. The display device includes a light guide plate in which a material transparent to light beams emitted from a plurality of light sources is formed into a plate shape, and one of surfaces of the light guide plate is formed as an outgoing surface facing an observer. At least one of side surfaces surrounding the outgoing surface of the light guide plate is formed as an incident surface opposed to a plurality of light sources that emit light beams having different colors. A plurality of prisms that reflect the light beam, which is emitted from any one of the plurality of light sources and is incident on the light guide plate, toward the outgoing surface are formed on the other surface of the light guide plate opposed to the outgoing surface. Each of the plurality of prisms is arrayed according to at least one pattern displayed by the display device. In the display device, arrangement density of the prisms that reflect the light beams from the light sources is set every light source according to the color of the pattern. The display device changes the color of a pattern by controlling the combination of the light source which turns on among the plurality of light sources. Consequently, the display device can display the pattern having a color obtained by mixing colors from a plurality of light sources, and can change the color of the pattern in various ways.

Hereinafter, for convenience, the side opposed to an observer is referred to as a front surface, and the opposite side is referred to as a back surface.

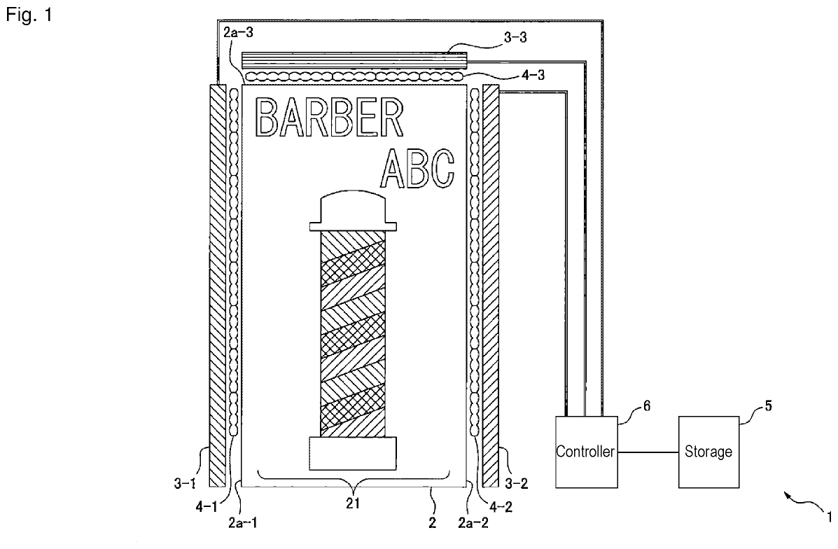

FIG. 1 is a schematic configuration diagram illustrating a display device according to a first embodiment of the present invention. A display device 1 includes a light guide plate 2, three light sources 3-1 to 3-3, three collimator lenses 4-1 to 4-3, a storage 5, and a controller 6.

The light guide plate 2 is a member formed into a plate shape transparent to the light beam emitted from each of the light sources 3-1 to 3-3. The light guide plate 2 is formed by molding a resin, such as polymethyl methacrylate (PMMA), polycarbonate, and cycloolefin polymer, which is transparent to the visible light beam. A pattern 21 that can be displayed by turn-on of the light sources 3-1 to 3-3 is provided in the light guide plate 2. That is, the light guide plate 2 causes the light beams emitted from the light sources 3-1 to 3-3 to propagate in the light guide plate 2 while the light sources 3-1 to 3-3 are turned on, and reflects the light beam toward the observer located within a predetermined angle range based on a normal direction of the outgoing surface on the front surface side using the plurality of prisms (details will be described later) formed on the back surface side and arrayed so as to form the pattern 21, which allows the observer to visually recognize the pattern 21 emitting the light beam.

Details of the light guide plate 2 will be described later.

Each of the light sources 3-1 to 3-3 includes at least one light emitting element that emits the visible light beam. In the embodiment, the light sources 3-1 to 3-3 are disposed so as to be opposed to incident surfaces 2a-1 to 2a-3 formed on three of four side surfaces of the light guide plate 2 while the collimator lenses 4-1 to 4-3 are interposed therebetween, respectively. That is, an emission surface of each light emitting element included in the light source 3-1 is opposed to the incident surface 2a-1 that is one of the side surfaces of the light guide plate 2, and the light emitting elements are arranged in a line along a longitudinal direction of the incident surface 2a-1. The emission surface of each light emitting element included in the light source 3-2 is opposed to the incident surface 2a-2, which is another side surface of the light guide plate 2 and is the side surface on the opposite side to the incident surface 2a-1, and the light emitting elements are arranged in a line along the longitudinal direction of the incident surface 2a-2. The emission surface of each light emitting element included in the light source 3-3 is opposed to the incident surface 2a-3 that is another side surface orthogonal to the incident surfaces 2a-1 and 2a-2 of the light guide plate 2, and the light emitting elements are arranged in a line along the longitudinal direction of the incident surface 2a-3.

The colors of the light beam emitted from the light sources 3-1 to 3-3 are different from one another. For example, the light source 3-1 emits a red light beam, the light source 3-2 emits a blue light beam, and the light source 3-3 emits a green light beam. While the controller 6 turns on the light source 3-1, the light beam emitted from the light source 3-1 is collimated by the collimator lens 4-1, and enters the light guide plate 2 through the incident surface 2a-1. The incident light beam is reflected by the prism in which a reflection surface is directed onto the side of the light source 3-1 among the plurality of prisms forming the pattern 21 provided on the diffusion surface 2b on the back surface side of the light guide plate 2 after propagating in the light guide plate 2, and exits from the outgoing surface 2c on the front surface side. Similarly, while the controller 6 turns on the light source 3-2, the light beam emitted from the light source 3-2 is collimated by the collimator lens 4-2, and enters the light guide plate 2 through the incident surface 2a-2. The incident light beam is reflected by the prism in which the reflection surface is directed onto the side of the light source 3-2 among the plurality of prisms forming the pattern 21 provided on the diffusion surface 2b after propagating in the light guide plate 2, and exits from the outgoing surface 2c. While the controller 6 turns on the light source 3-3, the light beam emitted from the light source 3-3 is collimated by the collimator lens 4-3, and enters the light guide plate 2 through the incident surface 2a-3. The incident light beam is reflected by the prism in which the reflection surface is directed onto the side of the light source 3-3 among the plurality of prisms forming the pattern 21 provided on the diffusion surface 2b after propagating in the light guide plate 2, and exits from the outgoing surface 2c.

For example, the light emitting element included in each of the light sources 3-1 to 3-3 is a light emitting diode. Emission luminance of each of the light sources 3-1 to 3-3 may be the same as or differ from each other.

The collimator lens 4-1 is disposed between the light source 3-1 and the incident surface 2a-1, and collimates the light beam emitted from each light emitting element included in the light source 3-1. When the light source 3-1 includes a plurality of light emitting elements arrayed in a line along the longitudinal direction of the incident surface 2a-1, the collimator lens 4-1 may be formed as a lens array in which a plurality of lenses are arrayed in a line along the longitudinal direction of the incident surface 2a-1. Each of the plurality of lenses is provided so as to correspond to any one of the plurality of light emitting elements in a one-to-one manner, collimates the light beam emitted from the corresponding light emitting element, and causes the light beam to enter the incident surface 2a-1 perpendicularly.

Similarly, the collimator lens 4-2 is disposed between the light source 3-2 and the incident surface 2a-2, and collimates the light beam emitted from each light emitting element included in the light source 3-2. When the light source 3-2 includes a plurality of light emitting elements arrayed in a line along the longitudinal direction of the incident surface 2a-2, the collimator lens 4-2 may be formed as the lens array in which the plurality of lenses are arrayed in a line along the longitudinal direction of the incident surface 2a-2. Each of the plurality of lenses is provided so as to correspond to any one of the plurality of light emitting elements in a one-to-one manner, collimates the light beam emitted from the corresponding light emitting element, and causes the light beam to enter the incident surface 2a-2 perpendicularly.

The collimating lens 4-3 is disposed between the light source 3-3 and the incident surface 2a-3, and collimates the light beam emitted from each light emitting element of the light source 3-3. When the light source 3-3 includes a plurality of light emitting elements arrayed in a line along the longitudinal direction of the incident surface 2a-3, the collimator lens 4-3 may be formed as the lens array in which the plurality of lenses are arrayed in a line along the longitudinal direction of the incident surface 2a-3. Each of the plurality of lenses is provided so as to correspond to any one of the plurality of light emitting elements in a one-to-one manner, collimates the light beam emitted from the corresponding light emitting element, and causes the light beam to enter the incident surface 2a-3 perpendicularly.

The collimator lenses 4-1 to 4-3 may be configured as refractive lenses or diffractive lenses such as a Fresnel zone plate. Each of the collimator lenses 4-1 to 4-3 may be a cylindrical lens that collimates the light emitted from the corresponding light source only in the longitudinal direction of the corresponding incident surface.

For example, the storage 5 includes a volatile or nonvolatile memory circuit. The storage 5 stores turn-on control information designating at least one light source to be turned on among the light sources 3-1 to 3-3.

For example, the controller 6 includes a processor and a drive circuit of the light sources 3-1 to 3-3. The controller 6 controls turn-on and turn-off of the light sources 3-1 to 3-3 according to the turn-on control information.

The turn-on control information and turn-on control of the light sources 3-1 to 3-3 according to the turn-on control information by the controller 6 will be described in detail later.

Timing of turning on or turning off the light sources 3-1 to 3-3 is designated by the turn-on control information. Thus, at the turn-on timing indicated by the turn-on control information, the controller 6 turns on the light sources 3-1 to 3-3 so that the pattern 21 is displayed. On the other hand, at the turn-off timing indicated by the turn-on control information, the controller 6 turns off the light sources 3-1 to 3-3 so that the pattern 21 is not visually recognized. When all the light sources 3-1 to 3-3 are always turned on, the controller 6 may always turn on the light sources 3-1 to 3-3 without referring to the turn-on control information while the display device 1 operates.

The details of the light guide plate 2 will be described below.

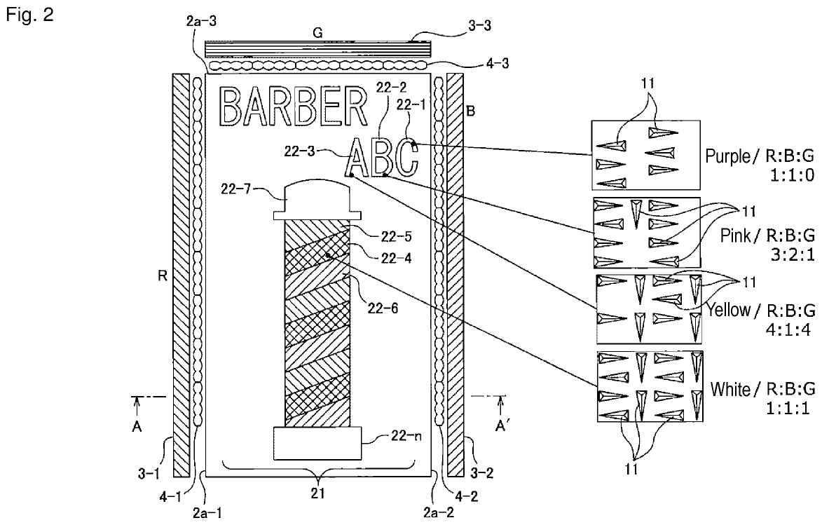

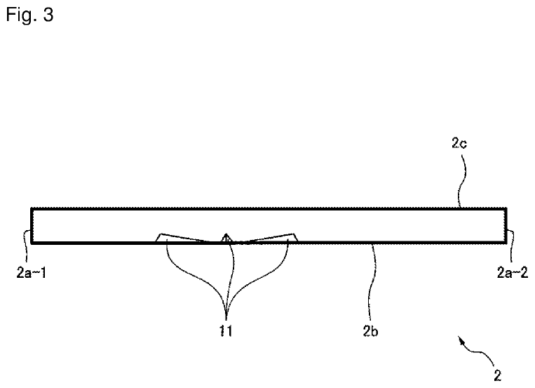

FIG. 2 is a schematic front view of the light guide plate 2. FIG. 3 is a schematic sectional side view illustrating the light guide plate 2 taken along line A-A′ in FIG. 2. As illustrated in FIGS. 2 and 3, one of the side surfaces of the light guide plate 2 is formed as the incident surface 2a-1 opposed to the light source 3-1. As described above, the light beam emitted from the light source 3-1 enters the light guide plate 2 from the incident surface 2a-1. The red light beam, which is emitted from the light source 3-1 and propagates in the light guide plate 2, is totally reflected by each prism in which the reflection surface is disposed so as to be opposed to the light source 3-1 among a plurality of prisms 11 arrayed along the pattern 21 and formed on the diffusion surface 2b located on the back surface side of the light guide plate 2. Then, the red light beam exits from the outgoing surface 2c located on the front surface side of the light guide plate 2 and opposed to the diffusion surface 2b.

The side surface of the light guide plate 2 on the opposite side to the incident surface 2a-1 is formed as the incident surface 2a-2 opposed to the light source 3-2. The blue light beam is emitted from the light source 3-2, enters the light guide plate 2 from the incident surface 2a-2, and propagates in the light guide plate 2. Then, the blue light beam is totally reflected by each prism in which the reflection surface is disposed so as to be opposed to the light source 3-2 among the plurality of prisms 11 arrayed along the pattern 21 and formed on the diffusion surface 2b, and the blue light beam exits from the outgoing surface 2c.

One of the side surfaces of the light guide plate 2 is formed as the incident surface 2a-3 opposed to the light source 3-3, one of side surfaces being orthogonal to the incident surfaces 2a-1, 2a-2. The green light beam is emitted from the light source 3-3, enters the light guide plate 2 from the incident surface 2a-3, and propagates in the light guide plate 2. Then, the green light beam is totally reflected by each prism in which the reflection surface is disposed so as to be opposed to the light source 3-3 among the plurality of prisms 11 arrayed along the pattern 21 and formed on the diffusion surface 2b, and the green light beam exits from the outgoing surface 2c.

Each prism reflects the light beam from each of the light sources 3-1 to 3-3 toward a direction within a predetermined angle range based on the normal direction of the outgoing surface 2c of the light guide plate 2. Thus, the observer can observe the pattern 21 that emits the light beam on the surface of the light guide plate 2 while at least one of the light sources 3-1 to 3-3 is turned on. In FIGS. 2 and 3, it is noted that a size of each prism and a thickness of the light guide plate 2 are exaggerated in order to improve visibility of the drawings.

In the embodiment, the pattern 21 is divided into a plurality of sub-patterns 22-1 to 22-n (n is an integer of 2 or more). When the entire pattern 21 has the same color, the pattern 21 may not be divided into the sub-patterns.

Each of the sub-patterns 22-1 to 22-n is an adjustment unit of the emission color. The plurality of prisms 11 are disposed in each sub-pattern such that the reflection surface is opposed to at least one of the light sources 3-1 to 3-3. The arrangement density of the prisms having the reflection surface opposed to each light source is set according to the emission color of each sub-pattern.

For example, it is assumed that the emission color of the sub-pattern 22-1 is purple. In this case, among the plurality of prisms 11 disposed in the sub-pattern 22-1, the arrangement density of the prisms disposed to direct the reflection surface to the light source 3-1 or 3-2 becomes relatively high. For example, the plurality of prisms 11 arranged in the sub-pattern 22-1 are disposed such that a ratio of the arrangement density of the prisms disposed to direct the reflection surface to the light source 3-1 (red), the arrangement density of the prisms disposed to direct the reflection surface to the light source 3-2 (blue), and the arrangement density of the prisms disposed to direct the reflection surface to the light source 3-3 (green) becomes 1:1:0.

It is assumed that the emission color of the sub-pattern 22-2 is pink. In this case, for example, the plurality of prisms 11 arranged in the sub-pattern 22-12 are disposed such that the ratio of the arrangement density of the prisms disposed to direct the reflection surface to the light source 3-1 (red), the arrangement density of the prisms disposed to direct the reflection surface to the light source 3-2 (blue), and the arrangement density of the prisms disposed to direct the reflection surface to the light source 3-3 (green) becomes 3:2:1.

It is assumed that the emission color of the sub-pattern 22-3 is yellow. In this case, for example, the plurality of prisms 11 arranged in the sub-pattern 22-3 are disposed such that the ratio of the arrangement density of the prisms disposed to direct the reflection surface to the light source 3-1 (red), the arrangement density of the prisms disposed to direct the reflection surface to the light source 3-2 (blue), and the arrangement density of the prisms disposed to direct the reflection surface to the light source 3-3 (green) becomes 4:1:4.

It is assumed that the emission color of the sub-pattern 22-4 is white. In this case, for example, the plurality of prisms 11 arranged in the sub-pattern 22-4 are disposed such that the ratio of the arrangement density of the prisms disposed to direct the reflection surface to the light source 3-1 (red), the arrangement density of the prisms disposed to direct the reflection surface to the light source 3-2 (blue), and the arrangement density of the prisms disposed to direct the reflection surface to the light source 3-3 (green) becomes 1:1:1.

It is assumed that the emission color of the sub-pattern 22-5 is red. In this case, for example, the plurality of prisms 11 arranged in the sub-pattern 22-5 are disposed such that the ratio of the arrangement density of the prisms disposed to direct the reflection surface to the light source 3-1 (red), the arrangement density of the prisms disposed to direct the reflection surface to the light source 3-2 (blue), and the arrangement density of the prisms disposed to direct the reflection surface to the light source 3-3 (green) becomes 1:0:0.

Similarly, it is assumed that the emission color of the sub-pattern 22-6 is blue. In this case, for example, the plurality of prisms 11 arranged in the sub-pattern 22-6 are disposed such that the ratio of the arrangement density of the prisms disposed to direct the reflection surface to the light source 3-1 (red), the arrangement density of the prisms disposed to direct the reflection surface to the light source 3-2 (blue), and the arrangement density of the prisms disposed to direct the reflection surface to the light source 3-3 (green) becomes 0:1:0.

The brightness may vary in each sub-pattern. In this case, the arrangement density of the prisms 11 in the sub-pattern increases with increasing brightness of the sub-pattern. An amount of light beam, which is reflected by the prisms arranged in the sub-pattern and exits from the outgoing surface 2c toward the front surface side, among the light beams emitted from the light sources 3-1 to 3-3 increases with increasing arrangement density of the prisms 11, so that the sub-pattern looks brighter.

For example, it is assumed that the emission color of the sub-pattern 22-7 is white, and that the brightness of the sub-pattern 22-7 is darker than that of the sub-pattern 22-4 that is also white. In this case, the arrangement density of the prisms 11 in the sub pattern 22-7 is lower than the arrangement density of the prisms 11 in the sub pattern 22-4.

In setting the arrangement density of the prisms for each corresponding light source according to the color of the sub-pattern, the arrangement density is determined by the number of prisms 11 per unit area when the sizes of the prisms 11 are the same as each other. That is, the arrangement density becomes high with increasing number of prisms 11 per unit area.

Alternatively, the number of prisms 11 per unit area may be identical in each light source. In this case, the size of the reflection surface of the prism corresponding to the light source may be increased with increasing ratio of the emission color to the color of the sub-pattern (that is, with increasing arrangement density).

For example, the plurality of prisms 11 may be staggered or latticed in the pattern 21, or randomly disposed such that the arrangement density of the prisms is kept constant in the sub-pattern. Even in any region of the size corresponding to resolution of eyes of the observer when the observer views the display device 1 separated from a position by an assumption distance between the observer and the light guide plate 2 in each sub-pattern, preferably the prisms are disposed so as to become the arrangement density set in each light source. Consequently, the individual sub-pattern is represented so as not to have color unevenness.

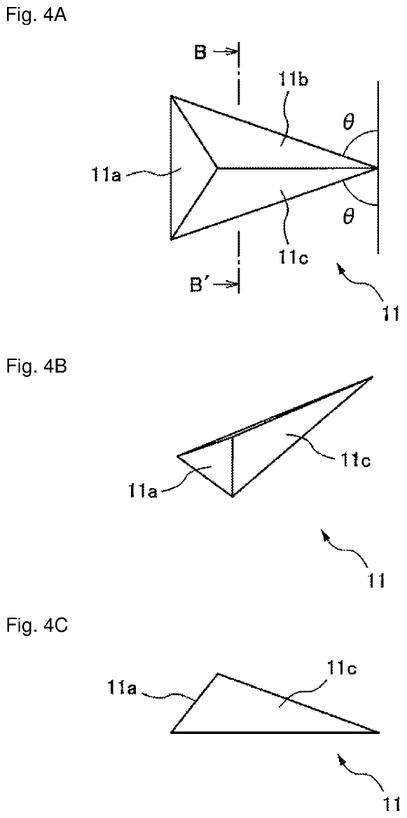

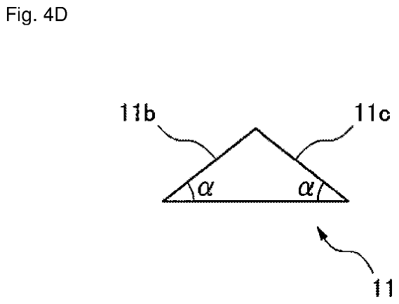

FIG. 4A is a schematic front view of the prism 11, and FIG. 4B is a schematic perspective view of the prism 11. FIG. 4C is a schematic side view of the prism 11. FIG. 4D is a schematic sectional view of the prism 11 taken along line B-B′ in FIG. 4A. For example, the prism 11 is formed as a triangular pyramid-shaped groove in which the diffusion surface 2b is used as a bottom surface. One of three slopes of the prism 11 is formed as a reflection surface 11a that forms a predetermined angle with respect to the diffusion surface 2b. The predetermined angle is set such that the light beam, which is emitted from the corresponding light source (for example, the light source 3-1) and is incident on the light guide plate 2, is totally reflected and directed toward a direction within a predetermined angle range based on the normal direction of the outgoing surface 2c. The other two of the three slopes of the prism 11 are formed as diffusion surfaces 11b, 11c that reflect the light beam toward the direction out of the predetermined angle range based on the normal direction of the outgoing surface 2c such that the observer cannot visually recognize the light beam emitted from the light source except for the corresponding light source (for example, for the prism that reflects the light beam emitted from the light source 3-1 toward the front surface side, the light beam emitted from the light sources 3-2 and 3-3).

Referring to FIG. 2 again, among the plurality of prisms 11, each prism that reflects the light beam from the light source 3-1 toward the front surface side is disposed such that the reflection surface 11a directly faces one of the light emitting elements of the light source 3-1, namely, such that the incident surface 2a-1 and the reflection surface 11a are substantially parallel to each other in a plane parallel to the diffusion surface 2b. Similarly, among each of the plurality of prisms 11, each prism that reflects the light beam from the light source 3-2 toward the front surface side is disposed such that the reflection surface 11a directly faces any one of the light emitting elements of the light sources 3-2, namely, such that the incident surface 2a-2 and the reflection surface 11a are substantially parallel to each other in the plane parallel to the diffusion surface 2b. Furthermore, among the plurality of prisms 11, each prism that reflects the light beam from the light source 3-3 toward the front surface side is disposed such that the reflection surface 11a directly faces any one of the light emitting elements of the light source 3-3, namely, such that the incident surface 2a-3 and the reflection surface 11a are substantially parallel to each other in the plane parallel to the diffusion surface 2b.

Consequently, the light beam is emitted from the light source 3-1, enters the light guide plate 2, and is directed to any one of the prisms that reflect the light beam from the light source 3-1 toward the front surface side. Then, the light beam is reflected by the reflection surface 11a of the prism, and exits from the outgoing surface 2c of the light guide plate 2 toward the observer located on the front surface side of the light guide plate 2. On the other hand, the light beam, which is emitted from the light source 3-2 or the light source 3-3, enters the light guide plate 2, and is directed to any one of the prisms that reflect the light beam from the light source 3-1 toward the front surface side, is reflected by the diffusion surface 11b or 11c of the prism toward the direction out of the predetermined angle range based on the normal direction of the outgoing surface 2c of the light guide plate 2 such that the observer does not visually recognize the light beam.

At this point, the direction in which the light beam emitted from the light source 3-2 and incident on the light guide plate 2 is reflected by the diffusion surface 11b or 11c of the prism is determined by a combination of an angle θ (hereinafter, referred to as a rotation angle for convenience) formed between the direction orthogonal to the propagation direction of light beam from the light source 3-2, namely, the direction parallel to the incident surface 2a-2 and the diffusion surface 11b or 11c of the prism and an angle α (hereinafter, referred to as an inclination angle for convenience) formed between the diffusion surface 2b of the light guide plate 2 and the diffusion surface 11b or 11c of the prism. Similarly, the direction in which the light beam emitted from the light source 3-3 and incident on the light guide plate 2 is reflected by the diffusion surface 11b or 11c of the prism is determined by the combination of the rotation angle θ and the inclination angle α. An angle formed between the reflected light beam and the normal direction of the outgoing surface 2c when the reflected light is emitted from the light guide plate 2 is affected by a refractive index of the material for the light guide plate 2.

For example, it is assumed that the predetermined angle range based on the direction in which the observer is located, namely, the normal direction of the outgoing surface 2c of the light guide plate 2 is within 30° from the normal direction of the outgoing surface 2c of the light guide plate 2. In this case, when the light guide plate 2 is made of polycarbonate (refractive index of 1.59) or PMMA (refractive index of 1.49), in order that the light emitted from the light source except for the corresponding light source and reflected by the diffusion surface 11b or 11c of each prism 11 is directed to the direction out of the predetermined angle range so as not to be directed to the observer, preferably each prism 11 is formed such that the rotation angles θ of the diffusion surfaces 11b, 11c are within the range of 25° to 65° while the inclination angles α of the diffusion surfaces 11b, 11c are within the range of 25° to 55°.

It is assumed that the predetermined angle range based on the normal direction of the outgoing surface 2c of the light guide plate 2 is within 45° from the normal direction of the outgoing surface 2c of the light guide plate 2. In this case, when the light guide plate 2 is made of polycarbonate or PMMA, in order that the light beam emitted from the light source except for the corresponding light source and reflected by the diffusion surface 11b or 11c of each prism 11 is directed to the direction out of the predetermined angle range, preferably each prism 11 is formed such that the rotation angle θ is within the range of 35° to 55° while the inclination angle α is within the range of 25° to 55°.

It is assumed that the predetermined angle range based on the normal direction of the outgoing surface 2c of the light guide plate 2 is within 60° from the normal direction of the outgoing surface 2c of the light guide plate 2. In this case, when the light guide plate 2 is made of polycarbonate or PMMA, in order that the light beam emitted from the light source except for the corresponding light source and reflected by the diffusion surface 11b or 11c of each prism 11 is directed to the direction out of the predetermined angle range, preferably each prism 11 is formed such that the rotation angle θ is within the range of 40° to 50° while the inclination angle α is within the range of 25° to 55°.

The turn-on control information and the turn-on control of the light sources 3-1 to 3-3 according to the turn-on control information by the controller 6 will be described in detail below.

The controller 6 can change the colors of the sub-patterns 22-1 to 22-n of the pattern 21 according to a set of light sources to be turned on among the light sources 3-1 to 3-3.

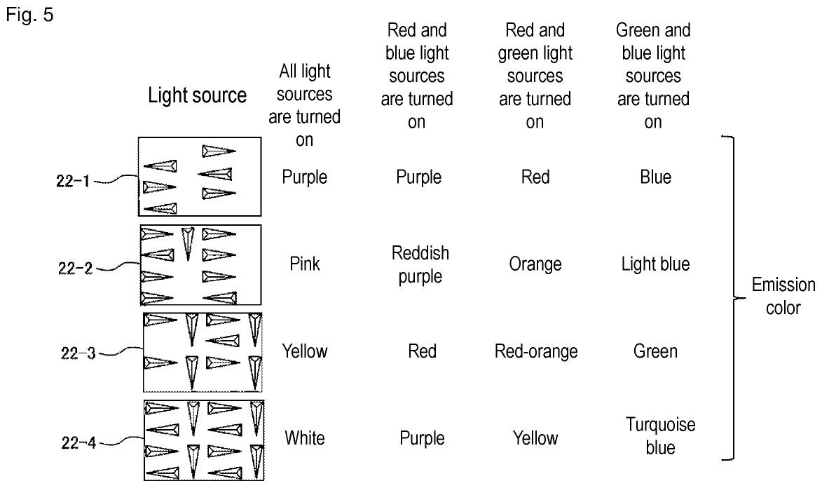

FIG. 5 is a view illustrating an example of a relationship between a combination of the light sources to be turned on and the color of each sub pattern. For example, when all the light sources 3-1 to 3-3 are turned on, as described above, the sub patterns 22-1 to 22-4 become purple, pink, yellow, and white, respectively.

When the light source 3-3 is turned off while the light source 3-1 (red) and the light source 3-2 (blue) are turned on, the color of the sub-pattern 22-1 that does not include the prism that reflects the light beam from the light source 3-3 toward the front surface side does not change, but the sub-patterns 22-2 to 22-4 become reddish purple, red, and purple, respectively. When the light source 3-2 is turned off while the light source 3-1 (red) and the light source 3-3 (green) are turned on, the sub-patterns 22-1 to 22-4 become red, orange, red-orange, and yellow, respectively. When the light source 3-1 is turned off while the light source 3-2 (blue) and the light source 3-3 (green) are turned on, the sub-patterns 22-1 to 22-4 become blue, light blue, green, and turquoise blue, respectively.

The sub-pattern 22-5 in which all the prisms reflect the light beam from the light source 3-1 toward the observer becomes red as long as the light source 3-1 is turned on, and the sub-pattern 22-5 cannot visually be recognized when the light source 3-1 is turned off. Similarly, the sub-pattern 22-6 in which all the prisms reflect the light beam from the light source 3-2 toward the observer becomes blue as long as the light source 3-2 is turned on, and the sub-pattern 22-6 cannot visually be recognized when the light source 3-2 is turned off.

As described above, the controller 6 can change the color of each sub-pattern by changing the combination of the light sources to be turned on. In the above example, at least two of the light sources 3-1 to 3-3 are turned on. Alternatively, the controller 6 may turn on only one of the light sources 3-1 to 3-3.

The controller 6 may adjust emission luminance of each of the light sources 3-1 to 3-3 according to the turn-on control information. For example, the controller 6 may cause the light sources 3-1 to 3-3 to emit the light beam with the identical emission luminance, or the controller 6 may set the emission luminance of any one of the light sources 3-1 to 3-3 higher than the emission luminances of the other light sources, and conversely the controller 6 may set the emission luminance of any one of the light sources lower than the emission luminances of the other light sources. The controller 6 may vary the emission luminances of the light sources 3-1 to 3-3. For each of the light sources 3-1 to 3-3, the emission luminance may be set to at least three stages. The controller 6 may turn on each of the light sources 3-1 to 3-3 at any one of the emission luminances at the set plurality of stages. In this way, the controller 6 can further increase the number of types of representable colors for each sub-pattern by adjusting not only turn-on and turn-off of each light source but also the emission luminance during the turn-on.

The order in which the light sources 3-1 to 3-3 are turned on may be designated by the turn-on control information. For example, the turn-on control information can be simply data representing an identification number identifying the light source to be turned on according to the turn-on order of the light sources 3-1 to 3-3. For example, it is assumed that “1” is the identification number of the light source 3-1, that “2” is the identification number of the light source 3-2, and that “3” is the identification number of the light source 3-3. For each previously-set period, it is assumed that the light source to be turned on is switched in the order of light sources 3-1 to 3-3→light source 3-1 and light source 3-2→light source 3-2 and light source 3-3→light source 3-1 and light source 3-3. In this case, the identification number of the turn-on control information may be represented in the order of (‘1’, ‘2’, ‘3’), (‘1’, ‘2’), (‘2’, ‘3’), (‘1’, ‘3’).

When the emission luminance during the turn-on of each light source is also adjusted, for example, the turn-on control information may have a parameter representing the emission luminance in association with the identification number of the light source to be turned on. For example, when the emission luminance is set at 10 stages of 0 to 9, the parameter representing the emission luminance may have any one of the values of 0 to 9.

The controller 6 may receive the turn-on control information from a control circuit of a device in which the display device 1 is incorporated, for example, and control the turn-on and turn-off of the light sources 3-1 to 3-3 and the emission luminance during the turn-on according to the received turn-on control information. In this case, the turn-on control information may simply include the identification number of the light source to be turned on and the parameter representing the emission luminance of the light source to be turned on in association with the identification number. When the emission luminance is not adjusted, the turn-on control information may simply include the identification number of the light source to be turned on.

As described above, in the display device, the plurality of light sources disposed so as to be opposed to the incident surface of the light guide plate emit the light beams having different colors. The plurality of prisms are disposed along the pattern displayed on the light guide plate, and the light beam emitted from each light source and incident on the light guide plate is reflected toward the front surface side to display the pattern. In each individual sub-pattern that is a setting unit of the emission color in the pattern, the arrangement density of the prisms having the reflection surfaces opposed to the light sources is set according to the emission color of the sub-pattern. This enables the display device to display the pattern of the color obtained by mixing the colors of the light beam emitted from the light sources, and to change the color in each individual sub-pattern. Thus, the display device can increase the number of types of colors representing the patterns provided on the light guide plate. Furthermore, the display device changes the color of each sub-pattern with time by changing the combination of the light sources that are simultaneously turned on or the combination of the light sources that are simultaneously turned on and the emission luminance of the light source to be turned on with time.

According to a first modification, the number of light sources is not limited to three, but may be two. For example, in the embodiment, the light source 3-3 may be omitted.

The number of light sources may be four or more. The colors of the light beams emitted from the light sources may be different from each other. For example, in the embodiment, the side surface of the light guide plate 2 on the opposite side to the incident surface 2a-3 may be formed as the incident surface, and a light source may further be provided so as to be opposed to the incident surface. In the first modification, any two or more of the plurality of light sources may emit the light beams having the same color.

According to a second modification, in order to express what is called a glittering feeling in the displayed pattern, each prism may be disposed such that the angle formed between the directly-facing direction with respect to the light source and the reflection surface is randomly changed in each prism within a predetermined angle range. At this point, the prism may be rotated altogether, or the prism may be formed so as to rotate only the reflection surface. The predetermined angle range may be set according to the angle range in which the observer can visually recognize the pattern based on the normal direction of the outgoing surface of the light guide plate, for example, about ±5° to ±about 10°.

According to a third modification, the collimator lens may be omitted. In the modification, each light source includes one light emitting element. The light beam emitted from each light source enters the light guide plate 2 through the incident surface opposed to the light source. The incident light beam spreads in the direction parallel to the incident surface as it propagates in the light guide plate 2.

Thus, in the third modification, preferably each prism 11 constituting the pattern 21 is formed such that the reflection surface 11a directly faces the corresponding light source, namely, such that the reflection surface 11a is located along an arc centered on the corresponding light source on a plane parallel to the diffusion surface 2b of the light guide plate 2. Consequently, each prism 11 can reflect the light beam emitted from the corresponding light source and incident on the light guide plate 2 toward the observer located within the predetermined angle range based on the normal direction of the outgoing surface 2c on the front surface side of the light guide plate 2 irrespective of the position in the pattern 21. On the other hand, the light beam emitted from the light source except for the corresponding light source and incident on the light guide plate 2 is reflected by the diffusion surface 11b or 11c of each prism 11, and is directed to the direction different from the direction in which the observer is located, namely, the direction out of the predetermined angle range based on the normal direction of the outgoing surface 2c.

According to a fourth modification, instead of two prisms corresponding to the light beams from two directions incident from the two incident surfaces orthogonal to each other, a prism formed such that the slopes facing the two directions constitute the reflection surfaces may be used. Similarly, instead of three or four prisms corresponding to light from three or four directions, a prism that are formed in a quadrangular pyramid shape may be used, each slope of the prism being formed as the reflection surface.

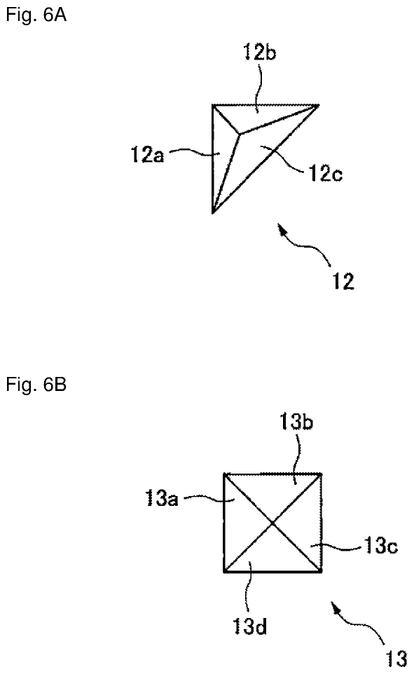

FIGS. 6A and 6B are views each illustrating an example of the shape of the prism according to the fourth modification. A prism 12 in FIG. 6A is formed in a triangular pyramid shape, and two of the three slopes are formed as reflection surfaces 12a, 12b. For example, the prism 12 is used instead of the prism formed such that the light source 3-1 and the reflection surface are opposed to each other and the prism formed such that the light source 3-3 and the reflection surface are opposed to each other. In this case, the reflection surface 12a of the prism 12 is formed so as to be opposed to the light source 3-1, and the reflection surface 12b is formed so as to be opposed to the light source 3-3. Thus, in the diffusion surface 2b of the light guide plate 2, the reflection surface 12a and the reflection surface 12b are orthogonal to each other. The remaining one of the three slopes of the prism 12 is formed as a diffusion surface 12c so as to be directed obliquely with respect to the propagation direction of the light beam from the light source 3-2. Consequently, the prism 12 reflects the light beam toward the observer located on the front surface side of the light guide plate 2 using the reflection surface 12a, the light beam being emitted from the light source 3-1 and being incident on the light guide plate 2, and reflects the light beam toward the observer located on the front surface side of the light guide plate 2 using the reflection surface 12b, the light beam being emitted from the light source 3-3 and being incident on the light guide plate 2. On the other hand, the light beam, which is emitted from the light source 3-2 and is incident on the light guide plate 2, is reflected by the diffusion surface 12c so as to be directed to the direction out of the predetermined angle range based on the normal direction of the outgoing surface 2c.

The prism 12 may be disposed such that the two reflection surfaces 12a, 12b are opposed to the light sources 3-2, 3-3, respectively. In this case, the prism 12 reflects the light beam toward the observer located on the front surface side of the light guide plate 2 using the reflection surface 12a, the light beam being emitted from the light source 3-2 and being incident on the light guide plate 2, and reflects the light beam toward the observer located on the front surface side of the light guide plate 2 using the reflection surface 12b, the light beam being emitted from the light source 3-3 and being incident on the light guide plate 2. On the other hand, the light beam, which is emitted from the light source 3-1 and is incident on the light guide plate 2, is reflected by the diffusion surface 12c so as to be directed to the direction out of the predetermined angle range based on the normal direction of the outgoing surface 2c.

A prism 13 in FIG. 6B is formed in a quadrangular pyramid shape, and each of the four slopes is formed as reflection surfaces 13a to 13d. For example, the prism 13 is used instead of the prism formed such that the light source 3-1 and the reflection surface are opposed to each other, the prism formed such that the light source 3-2 and the reflection surface are opposed to each other, and the prism formed such that the light source 3-3 and the reflection surface are opposed to each other. In this case, for example, the prism 13 may be disposed such that three of the reflection surfaces are opposed to the light sources 3-1 to 3-3.

According to the fourth modification, the display device can decrease the number of prisms disposed in the pattern. Thus, processing of the light guide plate is facilitated. The decrease in the density of the reflection surface of the prism per light source can be suppressed by decreasing the number of prisms, so that the decrease in brightness in a region where a plurality of patterns overlap each other can be suppressed.

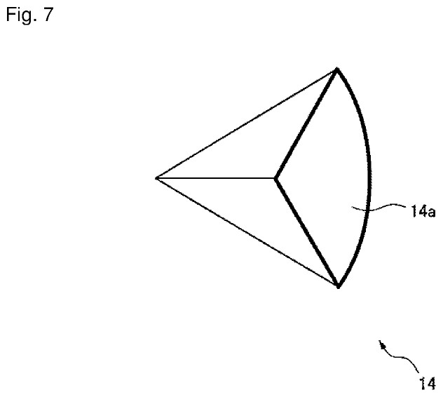

FIG. 7 is a schematic front view illustrating a prism according to a fifth modification formed on the light guide plate. A prism 14 of the fifth modification is different from the prism 11 of the embodiment in that a reflection surface 14a of the prism 14 is formed in a curved surface having a convex surface.

Consequently, the reflection direction changes depending on the position where the light beam emitted from the light source and propagating in the light guide plate enters the reflection surface 14a, so that the range where the observer can visually recognize the light beam emitted from the light guide plate 2 is widened. Thus, a viewing angle at which the pattern corresponding to the currently turned-on light source can visually be recognized is widened.

Even if the collimator lens is omitted and each light source includes the single light emitting element, the reflection surface 14a is prevented from shining in a dot shape.

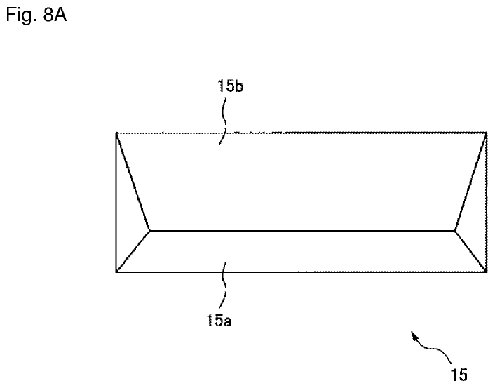

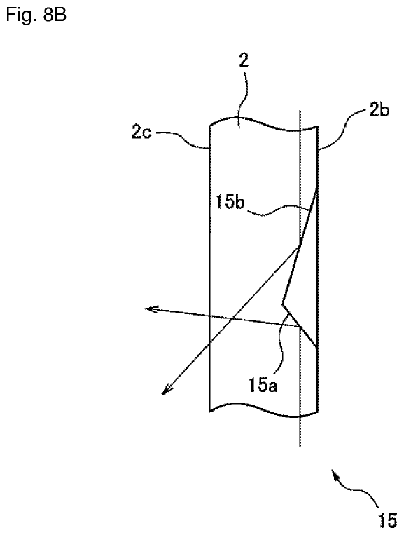

FIG. 8A is a schematic front view of a prism according to a sixth modification formed on the light guide plate, and FIG. 8B is a schematic side view illustrating the prism of the sixth modification. In the sixth modification, a prism 15 is formed as a triangular prism groove in the diffusion surface 2b of the light guide plate. One of the two slopes of the prism 15 is formed as a reflection surface 15a that reflects the light beam from the corresponding light source toward the direction out of the predetermined angle range based on the normal direction of the outgoing surface, and the other is formed as a diffusion surface 15b that reflects the light beam from the other light source toward the direction different from the direction in which the observer is located. In the sixth modification, the prism 15 is formed such that the inclination angle of the diffusion surface 15b is smaller than the inclination angle of the reflection surface 15a. Thus, the angle formed between the direction of the light beam reflected by the diffusion surface 15b and the normal direction of the outgoing surface 2c of the light guide plate 2 is larger than the angle formed between the direction of the light beam reflected by the reflection surface 15a and the normal direction of the outgoing surface 2c of the light guide plate 2. For this reason, the light beam reflected by the diffusion surface 15b is not visually recognized by the observer located on the front surface side of the light guide plate 2, or is totally reflected by the outgoing surface 2c of the light guide plate 2 but does not exit from the light guide plate 2.

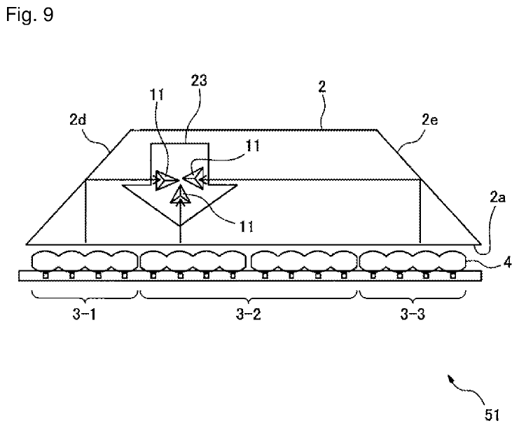

FIG. 9 is a schematic front view of a display device 51 according to a seventh modification. The storage and the controller are not illustrated in FIG. 9. The display device 51 of the seventh modification is different from the display device 1 in FIG. 1 in the shape of the light guide plate. In the display device 51, one of the side surfaces of the light guide plate 2 is formed as the incident surface 2a. Three light sources 3-1 to 3-3 are arranged in a line along the longitudinal direction of the incident surface 2a. The collimator lens 4 is disposed between the light sources 3-1 to 3-3 and the incident surface 2a. Thus, the light beam emitted from each of the light sources 3-1 to 3-3 is collimated by the collimator lens 4, and the collimated light beam enters the light guide plate 2 through the incident surface 2a. In the display device 51, the light sources 3-1 to 3-3 emit the light beams having different colors. For example, the light source 3-1 emits the red light beam, the light source 3-2 emits the blue light beam, and the light source 3-3 emits the green light beam.

In the seventh modification, the light guide plate 2 is formed in a trapezoidal shape, and the incident surface 2a is formed on the side surface corresponding to the bottom surface of the trapezoid. Two side surfaces 2d, 2e corresponding to the trapezoidal slope of the light guide plate 2 are formed as the reflection surfaces, the side surfaces 2d, 2e being adjacent to the incident surface 2a. The reflection surface 2d totally reflects the light beam, which is emitted from the light source 3-1 and propagates in the light guide plate 2, and changes the propagation direction of the light beam. For example, when the angle formed between the incident surface 2a and the reflection surface 2d is 45°, the light beam from the light source 3-1 totally reflected by the reflection surface 2d propagates in the direction substantially parallel to the longitudinal direction of the incident surface 2a. Thus, among the prisms 11 disposed in the pattern 23, the prism corresponding to the light source 3-1 may be formed such that the reflection surface faces the side of the reflection surface 2d.

Similarly, the reflection surface 2e totally reflects the light beam, which is emitted from the light source 3-3 and propagates in the light guide plate 2, and changes the propagation direction of the light beam. For example, when the angle formed between the incident surface 2a and the reflection surface 2e is 45°, the light beam from the light source 3-3 totally reflected by the reflection surface 2e propagates in the direction substantially parallel to the longitudinal direction of the incident surface 2a. Thus, among the prisms 11 disposed in the pattern 23, the prism corresponding to the light source 3-3 may be formed such that the reflection surface faces the side of the reflection surface 2e.

Thus, in the display device 51 of the seventh modification, even if the space where the light sources are disposed can be secured only on one side of the light guide plate, similarly to the display device 1 of the embodiment, the pattern having the color obtained by mixing the colors from the light sources can be displayed, and the color can be changed in each sub-pattern.

The display device of the embodiments or the modifications may be mounted on a game machine such as a pinball game machine or a reel game machine.

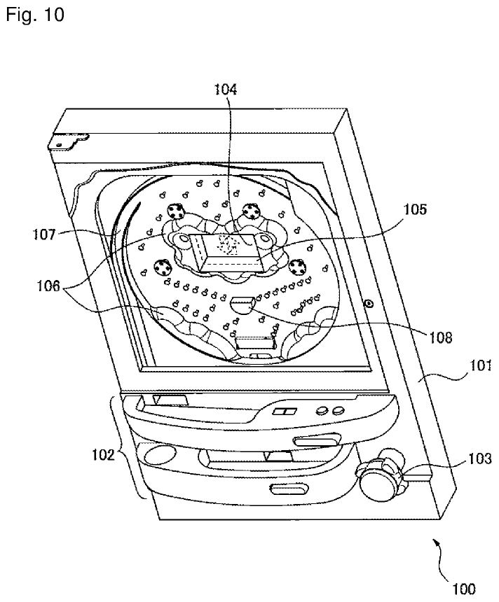

FIG. 10 is a schematic perspective view illustrating the pinball game machine including the display device of the embodiment or the modifications when the pinball game machine is viewed from a player side. As illustrated in FIG. 10, a pinball game machine 100 is provided in a most area from an upper portion to a central portion, and includes a game board 101 that is the game machine body, a ball receiving unit 102 provided below the game board 101, an operation unit 103 including a handle, a liquid crystal display 104 provided in the substantial center of the game board 101, and a display device 105 arranged in the front surface of the liquid crystal display 104.

The pinball game machine 100 also includes an accessory 106 arranged below the game board 101 or around the display device 105 in the front surface of the game board 101 for the purpose of game performance. A rail 107 is laterally disposed on the game board 101. A large number of obstacle nails (not illustrated) and at least one winning device 108 are provided on the game board 101.

The operation unit 103 shoots a game ball with predetermined force from a launcher (not illustrated) according to a turning amount of the handle by operation of the player. The shot game ball moves upward along the rail 107, and falls between a large number of obstacle nails. Then, when a sensor (not illustrated) detects that the game ball enters any one of winning devices 108, a main control circuit (not illustrated) provided on the back surface of the game board 101 dispenses a predetermined number of game balls corresponding to the winning device 108 that the game ball enters to the ball receiving unit 102 through a ball delivery device (not illustrated). The main control circuit drives the liquid crystal display 104 and the display device 105 through a performance CPU (not illustrated) provided on the back surface of the game board 101. The performance CPU transmits a control signal including the turn-on control information corresponding to a game state to the display device 105.

The display device 105 is an example of the display device of the embodiment or the modifications, and is attached to the game board 101 such that the outgoing surface of the light guide plate faces the player. The controller of the display device 105 turns on one of the plurality of light sources according to the turn-on control information included in the control signal from the performance CPU, so that the player can visually recognize the pattern together with video displayed on the liquid crystal display 104. Furthermore, the controller of the display device 105 changes the combination of the light sources to be turned on according to the turn-on control information, or changes the emission luminance of each light source to be turned on, which allows the change of the colors of the pattern and each sub-pattern included in the pattern. Alternatively, the controller may turn off all the light sources according to the turn-on control information so that the player can observe only the video displayed on the liquid crystal display 104 through the light guide plate.

Thus, those skilled in the art can make various modifications within the scope of the present invention according to the embodiment to be implemented.

### DESCRIPTION OF SYMBOLS

1, 51 display apparatus

2 light guide plate

2a, 2a-1 to 2a-3 incident surface

2b diffusion surface

2c outgoing surface

2d, 2e reflection surface

3-1 to 3-3 light source

11 to 15 prism

11a, 12a, 12b, 13a to 13d, 14a, 15a reflection surface

11b, 11c, 12c, 14b, 15b diffusion surface

21, 23 pattern

22-1 to 22-n sub-pattern

4, 4-1 to 4-4 collimator lens

5 storage

6 controller

100 pinball game machine

101 game board

102 ball receiving unit

103 operation unit

104 liquid crystal display

105 display apparatus

106 accessory

107 rail

108 winning device

1. A display device comprising:
a light guide plate configured to display at least one pattern, the light guide plate being made of a transparent material and including at least one incident surface;
a plurality of light sources configured to emit light beams having different colors, the plurality of light sources being disposed to be opposed to any one of the at least one incident surface; and
a controller configured to control turn-on and turn-off of the plurality of light sources according to turn-on control information designating at least one light source to be turned on among the plurality of light sources,
wherein the light guide plate includes a plurality of prisms that are arrayed along the pattern on one surface of the light guide plate and reflect the light beams emitted from the plurality of light sources and incident on the light guide plate from the incident surface such that the light beams exit from the other surface of the light guide plate,
wherein arrangement density of the prisms that reflect the light beam from the light source among the plurality of prisms is set for each of the plurality of light sources according to color of the pattern when each of the plurality of light sources is turned on, and
wherein the turn-on control information further designates order in which each of the plurality of light sources becomes the at least one light source to be turned on, and the color of the pattern changes according to the order.

2. The display device according to claim 1, wherein the turn-on control information further includes a parameter designating emission luminance of each of the at least one light source to be turned on.

3. (canceled)

4. The display device according to claim 1, wherein the plurality of patterns include a first sub-pattern having a first color when each of the plurality of light sources is turned on and a second sub-pattern having a second color when each of the plurality of light sources is turned on,
according to the first color, the arrangement density of the prisms arrayed along the first sub-pattern and reflecting the light beam from each light source among the plurality of prisms is set for each of the plurality of light sources, and
according to the second color, the arrangement density of the prisms arrayed along the second sub-pattern and reflecting the light beam from each light source among the plurality of prisms is set for each of the plurality of light sources.

5. A game machine comprising:
a game machine body; and
a display device provided on a surface of the game machine body on a side opposed to a player,
wherein the display device includes:
a light guide plate configured to display at least one pattern, the light guide plate being made of a transparent material and including at least one incident surface;
a plurality of light sources configured to emit light beams having different colors, the plurality of light sources being disposed to be opposed to any one of the at least one incident surface; and
a controller configured to control turn-on and turn-off of the plurality of light sources according to turn-on control information designating at least one light source to be turned on among the plurality of light sources,
the light guide plate includes a plurality of prisms that are arrayed along the pattern on one surface of the light guide plate and reflect the light beams emitted from the plurality of light sources and incident on the light guide plate from the incident surface such that the light beams exit from the other surface of the light guide plate,
arrangement density of the prisms that reflect the light beam from the light source among the plurality of prisms is set for each of the plurality of light sources according to color of the pattern when each of the plurality of light sources is turned on, and
the turn-on control information further designates order in which each of the plurality of light sources becomes the at least one light source to be turned on, and the color of the pattern changes according to the order.
